(19) United States
(12) Patent Application Publication
(10) Pub. No.: US 2025/0002338 A1
(43) Pub. Date: Jan. 2, 2025

(54) LOW-CARBON HYDROGEN PROCESS

(71) Applicant: Johnson Matthey Public Limited Company, London (GB)

(72) Inventors: David DAVIS, Billingham Cleveland (GB); Gabriele GERMANI, Billingham Cleveland (GB)

(21) Appl. No.: 18/710,046

(22) PCT Filed: Jan. 11, 2023
(86) PCT No.: PCT/GB2023/050040

§ 371 Date: May 14, 2024

(30) Foreign Application Priority Data
Feb. 2, 2022 (GB) 2201332.0

(51) Int. Cl. C01B 3/38; C01B 3/48; C01B 3/56; F01K 19/00

(52) U.S. Cl. CPC C01B 3/382; C01B 3/48; C01B 3/56; F01K 19/00; C01B 2203/0233; C01B 2203/0244; C01B 2203/0283; C01B 2203/0415; C01B 2203/0475; C01B 2203/0827; C01B 2203/1241; C01B 2203/127; C01B 2203/84

(57) ABSTRACT

A process for the production of hydrogen comprising the steps of: (i) subjecting a gaseous mixture comprising a hydrocarbon and steam to steam reforming in reformer followed by autothermal reforming with an oxygen-rich gas to generate a reformed gas mixture, (ii) increasing the hydrogen content of the reformed gas mixture by subjecting it to one or more water-gas shift stages in a water-gas shift unit to provide a hydrogen-enriched reformed gas, (iii) passing the hydrogen-enriched reformed gas and an oxygen-rich gas to an oxidation unit containing an oxidation catalyst that converts carbon monoxide present in the hydrogen-enriched reformed gas to carbon dioxide, to form a carbon-dioxide enriched gas mixture, (iv) cooling the carbon dioxide-enriched gas mixture and separating condensed water therefrom, and (v) passing the carbon dioxide enriched gas mixture to a carbon dioxide separation unit to provide a carbon dioxide gas stream and a hydrogen product gas stream.

This invention relates to processes for the conversion of hydrocarbons to hydrogen whilst minimising carbon dioxide production and emission.

Processes for generating hydrogen are well-known and generally include a fired steam methane reformer combined with water-gas shift and carbon dioxide (CO₂) removal. Such processes create significant volumes of carbon dioxide in flue gases at pressures unsuitable for efficient CO₂ capture. A common goal is to increase the rate of progress towards the net zero objective. There is, in the interim, a need for hydrogen production processes that generate lower levels of carbon dioxide effluent and enable more efficient CO₂ capture.

In support of this, blue hydrogen or low-carbon hydrogen processes are in development. A process for low-carbon hydrogen is disclosed in an article published in The Chemical Engineer, (Mar. 15, 2019) entitled “Clean Hydrogen. Part 1: Hydrogen from Natural Gas through Cost Effective CO₂ Capture”. The process disclosed in the article comprised steps of desulphurisation, saturation, reforming in a gas-heated reformer and oxygen-fed autothermal reformer, isothermal temperature shift, cooling, condensate removal and pressure swing adsorption (PSA). The percentage of CO₂ captured was 95.4% for the LCH process.

We have developed an improved process where carbon dioxide emissions are reduced.

Accordingly, the invention provides a process for the production of hydrogen comprising the steps of:
(i) subjecting a gaseous mixture comprising a hydrocarbon and steam to steam reforming in a gas-heated reformer or adiabatic pre-reformer followed by autothermal reforming with an oxygen-rich gas in an autothermal reformer to generate a reformed gas mixture,
(ii) increasing the hydrogen content of the reformed gas mixture by subjecting it to one or more water-gas shift stages in a water-gas shift unit to provide a hydrogen-enriched reformed gas,
(iii) passing the hydrogen-enriched reformed gas and an oxygen-rich gas to an oxidation unit containing an oxidation catalyst that converts carbon monoxide present in the hydrogen-enriched reformed gas to carbon dioxide, to form a carbon-dioxide enriched gas mixture,
(iv) cooling the carbon dioxide-enriched gas mixture and separating condensed water therefrom, and
(v) passing the carbon dioxide enriched gas mixture to a carbon dioxide separation unit to provide a carbon dioxide gas stream and a hydrogen product gas stream.

By using an oxidation catalyst in the oxidation unit to convert carbon monoxide to carbon dioxide, which is subsequently removed by the carbon dioxide separation unit, lower CO₂ emissions can be achieved. Moreover, a fuel grade hydrogen product gas stream may be achieved without the use of an expensive PSA unit. Moreover, an adjustable portion of the product hydrogen may be combusted to provide the heating and power duties of the process therefore significantly increasing plant operational flexibility.

The present invention can provide all of the product hydrogen at elevated pressure, which paves the way for more exergy-efficient methods of utilizing the hydrogen as a fuel or as a feedstock for downstream processes.

The present invention uses a gaseous mixture comprising a hydrocarbon.

The gaseous mixture may comprise any gaseous or low boiling hydrocarbon, such as natural gas, associated gas, LPG, petroleum distillate, diesel, naphtha or mixtures thereof, or hydrocarbon-containing off-gases from chemical processes, such as a refinery off-gas. The gaseous mixture preferably comprises methane, associated gas or natural gas containing a substantial proportion, e.g. over 50% v/v methane. Natural gas is especially preferred. The hydrocarbon may be compressed to a pressure in the range 10-100 bar abs. The pressure of the hydrocarbon may usefully govern the pressure throughout the process. Operating pressure is preferably in the range 15-50 bar abs, more preferably 25-50 bar abs as this provides an enhanced performance from the process.

If the hydrocarbon contains sulphur compounds, before, or preferably after, compression it may be subjected to desulphurisation comprising hydrodesulphurisation using CoMo or NiMo catalysts, and absorption of hydrogen sulphide using a suitable hydrogen sulphide adsorbent, e.g. a zinc oxide adsorbent. An ultra-purification adsorbent may usefully be employed downstream of the hydrogen sulphide adsorbent to further protect the steam reforming catalyst. Suitable, ultra-purification adsorbents may comprise copper-zinc oxide/alumina materials and copper-nickel-zinc oxide/alumina materials. To facilitate hydrodesulphurisation and/or reduce the risk of carbon laydown in the reforming process, hydrogen is preferably added to the compressed hydrocarbon. The amount of hydrogen in the resulting mixed gas stream may be in the range 1-20% vol, but is preferably in the range 1-10% vol, more preferably in the range 1-5% vol on a dry gas basis. In a preferred embodiment, a portion of the hydrogen product stream may be mixed with the compressed hydrocarbon. Hydrogen may be combined with the hydrocarbon upstream and/or downstream of any hydrodesulphurisation stage.

If the hydrocarbon contains other contaminants, such as chloride or heavy metal contaminants, these may be removed, prior to reforming, upstream or downstream of any desulphurisation, using conventional adsorbents. Adsorbents suitable for chloride removal are known and include alkalised alumina materials. Similarly, adsorbents for heavy metals such as mercury or arsenic are known and include copper sulphide materials.

The hydrocarbon may be pre-heated. It may conveniently be pre-heated after compression and before desulphurisation. Various hot gas sources are provided in the present process that may be used for this duty. However, in a preferred embodiment, the hydrocarbon is heated by passing it through a fired heater fuelled by a portion of hydrogen product stream.

The hydrocarbon is mixed with steam. The steam introduction may be performed by direct injection of steam and/or by saturation of the hydrocarbon by contact with a stream of heated water. In some arrangements, a gaseous mixture comprising the hydrocarbon and steam may be formed by directly mixing the hydrocarbon with steam, for example steam generated in one or more fired heaters and/or from cooling the reformed gas mixture with water. In other arrangements, the hydrocarbon may be saturated in a saturator fed with hot water to form a saturated gas mixture. The water may comprise one or more of the condensate streams produced in the process. The steam content of the saturated gas mixture may, if desired, be increased by the direct addition of steam.

In arrangements using a gas-heater reformer and autothermal reformer, the amount of steam introduced is desirably sufficient to give a steam to carbon ratio at the inlet to the reforming unit operations of at least 2.5:1, i.e. at least 2.5 moles of steam per gram atom of hydrocarbon carbon in the gaseous mixture. Because of the efficient utilisation of energy in the process, the steam to carbon ratio may be high, which maximises hydrogen production. The steam to carbon ratio may usefully be up to about 5:1.

In arrangements using an adiabatic prereformer and autothermal reformer, the amount of steam introduced is desirably sufficient to give a steam to carbon ratio (defined as the steam to hydrocarbon carbon ratio at the inlet to reforming unit operations) of at least 0.9:1, i.e. at least 0.9 moles of steam per gram atom of hydrocarbon carbon in the gaseous mixture, with a preferred range of 0.9:1 to 5:1. Where the steam to carbon ratio at the inlet to the reforming unit operations is in the range 0.9:1 to less than 2.4:1, it is desirable to add additional steam to the reformed gas upstream of the water-gas shift stage. Operating the reforming section at a steam to carbon ratio in the range of 0.9:1 to less than 2.4:1 has the advantage that the heating requirement and oxygen demand for the reforming stages is reduced. Where the steam to carbon ratio is in the range 2.4:1 to 5:1, no further steam addition upstream of the water-gas shift unit is necessary, which may be useful in circumstances where steam addition to the reformed gas is impractical.

The gaseous mixture comprising hydrocarbon and steam is then desirably pre-heated prior to reforming. In a preferred embodiment, the gaseous mixture is heated by passing it through a fired heater fuelled by a portion of the hydrogen product stream, in particular through the same fired heater used to pre-heat the hydrocarbon. Desirably, the mixed stream is heated to 400-500° C., preferably 420-460° C.

In some arrangement, the invention comprises a stage of adiabatic pre-reforming upstream of the autothermal reformer. In these arrangements, the gaseous mixture comprising the hydrocarbon and steam is subjected to a step of adiabatic steam reforming in a pre-reformer vessel containing a fixed bed of a pre-reforming catalyst. In such a process, the gaseous mixture comprising the hydrocarbon and steam, typically at an inlet temperature in the range of 400-650° C., is passed adiabatically through a bed of a steam reforming catalyst, usually a steam reforming catalyst having a high nickel content, for example above 40% by weight. During such an adiabatic pre-reforming step, any hydrocarbons higher than methane react with steam to give a mixture of methane, carbon oxides and hydrogen. The use of such an adiabatic steam reforming step, commonly termed pre-reforming, can be desirable to ensure that the feed to the autothermal reformer contains no hydrocarbons higher than methane and also contains some hydrogen.

In other arrangements, the gaseous mixture comprising the hydrocarbon and steam is subjected to steam reforming in a gas-heated reformer.

In one type of gas-heated reformer, the catalyst is disposed in tubes extending between a pair of tube sheets through a heat exchange zone. Reactants are fed to a zone above the upper tube sheet and pass through the tubes and into a zone beneath the lower tube sheet. The heating medium is passed through the zone between the two tube sheets. The heating medium is typically a hot reformed gas recovered from the autothermal reformer. Gas-heated reformers of this type are described in GB1578 270 and WO97/05 947. Another type of gas-heated reformer that may be used is a double-tube gas-heated reformer as described in U.S. Pat. No. 4,910,228 wherein the reformer tubes each comprise an outer tube having a closed end and an inner tube disposed concentrically within the outer tube and communicating with the annular space between the inner and outer tubes at the closed end of the outer tube with the steam reforming catalyst disposed in said annular space. The external surface of the outer tubes is heated by the heating medium. The reactant mixture is fed to the end of the outer tubes remote from said closed end so that the mixture passes through said annular space and undergoes steam reforming and then passes through the inner tube.

The compressed, pre-heated gaseous mixture comprising the hydrocarbon and steam is passed through the catalyst-filled tubes in the gas-heated reformer. During passage through the reforming catalyst, the endothermic steam reforming reaction takes place with the heat required for the reaction supplied by a hot reformed gas recovered from the autothermal reformer, which flows past the exterior surface of the tubes. The steam reforming catalyst used in the gas-heated reformer may comprise nickel supported on a particulate refractory support such as rings or multi-holed pellets of calcium aluminate, magnesium aluminate, alumina, titania, zirconia and the like. Alternatively, a combination of nickel and a precious metal such as ruthenium, may be used. In place of, or in addition to, the particulate steam reforming catalyst, the steam reforming catalyst may comprise one or more structured catalyst units, which may be in the form of metal or ceramic monoliths or folded metal structures on which a layer of nickel and/or precious metal steam reforming catalyst has been deposited. Such structured catalysts are described for example in WO2012/103432 A1 and WO2013151885 (A1). The temperature of the autothermally reformed gas used to heat the gas-heated reformer is preferably sufficient that the gas undergoing steam reforming leaves the catalyst tubes at a temperature in the range 600-850° C., preferably 650-750° C., more preferably 680-720° C.

In the present invention the pre-reformed gas or the steam reformed gas, which comprises methane, hydrogen, steam and carbon oxides, are fed, preferably without any dilution or heat exchange, directly to an autothermal reformer in which it is subjected to autothermal reforming. The pre-reformer or gas-heated reformer and the autothermal reformer are therefore operated in series.

The autothermal reformer may comprise an elongate vessel arranged vertically, having a burner disposed at the top of the reformer, to which the pre-reformed or steam reformed gas and the oxygen-rich gas are fed, a combustion zone beneath the burner through which a flame extends, and a fixed bed of particulate steam reforming catalyst disposed below the combustion zone. In autothermal reforming, the heat for the endothermic steam reforming reactions is therefore provided by combustion of a portion of hydrocarbon in the feed gas. The pre-reformed or steam reformed gases are typically fed to the top of the reformer and the oxygen-rich gas fed to the burner, mixing and combustion occur downstream of the burner generating a heated gas mixture the composition of which is brought to equilibrium as it passes through the steam reforming catalyst. The autothermal steam reforming catalyst may comprise nickel supported on a refractory support such as rings or pellets of calcium aluminate, magnesium aluminate, alumina, titania, zirconia and the like. In a preferred embodiment, the autothermal steam reforming catalyst comprises a layer of a catalyst comprising Ni and/or Ru on zirconia over a bed of a Ni on alumina catalyst to reduce catalyst support volatilisation that can result in deterioration in performance of the autothermal reformer.

The oxygen-rich gas may comprise at least 50% vol O₂ and may be an oxygen-enriched air mixture. However, in the present invention the oxygen-rich gas preferably comprises at least 90% vol O₂, more preferably at least 95% vol O₂, most preferably at least 98% vol O₂, or at least 99% vol O₂, e.g. a pure oxygen gas stream, which may be obtained using a vacuum pressure swing adsorption (VPSA) unit or an air separation unit (ASU). The ASU may be electrically driven and is desirably driven using renewable electricity to further improve the efficiency of the process and minimise CO₂ emissions.

The amount of oxygen-rich gas added is preferably such that 40 to 60 moles of oxygen are added per 100 moles of carbon in the hydrocarbon fed to the process. Preferably the amount of oxygen added is such that the reformed gas leaves the catalyst in the autothermal reformer at a temperature in the range 800-1100° C., more preferably 900-1100° C., most preferably 970-1070° C. In a preferred embodiment, a small purge of steam may be added to the oxygen-rich gas to protect against reverse flow if the plant trips.

In arrangements comprising a pre-reformer and autothermal reformer, the autothermally reformed gas is cooled in heat exchange with water, e.g., in a waste-heat boiler, to generate steam. This steam may be used for heating and/or for power generation in a steam turbine.

In arrangements comprising a gas-heated reformer and an autothermal reformer, the reformed gas produced by the autothermal reformer is used to provide the heat required for the steam reforming step by using it as the hot gas flowing past the tubes in the gas-heated reformer. During this heat exchange, the reformed gas cools by transferring heat to the gas undergoing steam reforming. Preferably, the reformed gas cools by several hundred degrees Centigrade but it will leave the gas-heated reformer at a temperature somewhat above the temperature at which the gaseous mixture comprising hydrocarbon and steam mixture is fed to the gas-heated reformer. Preferably the reformed gas leaves the gas-heated reformer at a temperature in the range 450-650° C., more preferably 450-580° C. After leaving the gas-heated reformer, the reformed gas is desirably then further cooled in one or more steps of heat exchange. Heat recovered during this cooling may be employed for reactants pre-heating and/or for heating water used to provide the steam employed in the steam reforming step. In some arrangements, the reformed gas mixture exiting the shell side of the gas-heated reformer may be used to heat water fed to a saturator.

Heat recovered from the autothermally reformed gas may additionally, or alternatively, be used in the carbon dioxide separation step.

The reformed gas comprises hydrogen, carbon monoxide, carbon dioxide, steam, and a small amount of unreacted methane, and may also contain small amounts of inert gases such as nitrogen and argon. Preferably, the hydrogen content of the reformed gas is in the range 30-45% vol on a wet gas basis and the carbon monoxide content in the range 5-15% vol on a wet gas basis. In the present invention, the hydrogen content of the reformed gas mixture is increased by subjecting it to one or more water-gas shift stages thereby producing a hydrogen-enriched reformed gas and at the same time converting carbon monoxide in the reformed gas to carbon dioxide. The reaction may be depicted as follows;

CO+H₂O⇄CO₂+H₂

Whereas steam is present in the reformed gas, supplemental steam may be added before the one or more water gas shift stages, e.g. by direct addition to the reformed gas, if desired.

The reformed gas may be subjected in the water-gas shift unit to one or more water-gas shift stages to form a hydrogen-enriched reformed gas stream, or “shifted” gas stream. The one or more water-gas shift stages may include stages of high-temperature shift, medium-temperature shift, isothermal shift and low-temperature shift.

High-temperature shift is operated adiabatically in a shift vessel with inlet temperature in the range 300-400° C., preferably 320-360° C., over a bed of a reduced iron catalyst, such as chromia-promoted magnetite. Alternatively, a promoted zinc-aluminate catalyst may be used.

Medium-temperature shift and low-temperature shift stages may be performed using shift vessels containing supported copper-catalysts, particularly copper/zinc oxide/alumina compositions. In low-temperature shift, a gas containing carbon monoxide (preferably ≤6% vol CO on a dry basis) and steam (at a steam to total dry gas molar ratio in range 0.3 to 1.5) may be passed over the catalyst in an adiabatic fixed bed with an outlet temperature in the range 200 to 300° C. The outlet carbon monoxide content may be in the range 0.1 to 1.5%, especially under 0.5% vol on a dry basis if additional steam is added. Alternatively, in medium-temperature shift, the gas containing carbon monoxide and steam may be fed to the catalyst at an inlet temperature in the range 200 to 240° C. although the inlet temperature may be as high as 280° C. The outlet temperature may be up to 300° C. but may be as high as 360° C.

Whereas one or more adiabatic water-gas shift stages may be employed, such as a high-temperature shift stage, optionally followed by a low-temperature shift stage, the reformed gas is preferably subjected to a stage of isothermal water-gas shift in a cooled shift vessel, optionally followed by one or more adiabatic medium- or low-temperature water-gas shift stages in un-cooled vessels as described above. Using an isothermal shift stage, i.e. with heat exchange in the shift converter such that the exothermic reaction in the catalyst bed occurs in contact with heat exchange surfaces that remove heat, offers the potential to use the reformed gas stream in a very efficient manner. Whereas the term “isothermal” is used to describe a cooled shift converter, there may be a small increase in temperature of the gas between inlet and outlet, so that the temperature of the hydrogen-enriched reformed gas stream at the exit of the isothermal shift converter may be between 1 and 25 degrees Celsius higher than the inlet temperature. The coolant conveniently may be water under pressure such that partial, or complete, boiling takes place. The water can be in tubes surrounded by catalyst or vice versa. The resulting steam can be used, for example, to drive a turbine, e.g. for electrical power, or to provide process steam for supply to the process. In a preferred embodiment, steam generated by the isothermal shift stage is used to supplement the steam addition to the gaseous mixture comprising a hydrocarbon and steam upstream of the pre-reformer or gas-heated reformer.

Addition of an adiabatic medium- or low-temperature shift stage downstream of the isothermal shift stage offers the potential to increase the CO₂ capture efficiency from the process to 98% or higher. However, we have found that excellent efficiency may be provided by a single isothermal shift converter.

The hydrogen-enriched reformed gas contains steam. In some embodiments it may be desirable, following the one or more water-gas shift stages, to cool the hydrogen-enriched reformed gas to a temperature below the dew point so that at least a portion of the steam condenses. The liquid water condensate may then be separated using one or more gas-liquid separators, which may have one or more further cooling stages between them, to form a de-watered hydrogen-enriched reformed gas. Any coolant may be used. Preferably, cooling of the hydrogen-enriched reformed gas is carried out in heat exchange with the process condensate. As a result, a stream of heated water, which may be used to supply some or all of the steam required for reforming, is formed. Thus, in some arrangements, condensate recovered from the hydrogen-enriched reformed gas is used to provide at least a portion of steam for the gas mixture fed to the steam reforming step. Because the condensate may contain ammonia, methanol, hydrogen cyanide and CO₂, returning the condensate to form steam offers a useful way of returning hydrogen and carbon to the process. One or more stages of cooling and condensate recovery may be included upstream of the oxidation unit, however in a preferred arrangement there is a single stage of cooling and condensate recovery such that the oxidation unit is installed after a first gas-liquid separator.

In other embodiments, the oxidation unit may be installed downstream of the water-gas shift unit, with no cooling and condensate separation in between. In this case, the oxidation unit is directly fed with the hydrogen-enriched reformed gas containing steam.

In the present invention, the hydrogen-enriched reformed gas, optionally after cooling and separation of condensate, is fed to an oxidation unit. In the oxidation unit, carbon monoxide present in the hydrogen-enriched reformed gas is oxidised to carbon dioxide. An oxygen-rich gas is added to the hydrogen-enriched reformed gas. Some hydrogen is also oxidised to form water. Accordingly, the oxidation catalyst is preferably a CO-selective oxidation catalyst to minimise hydrogen losses.

The oxidation reactions may be depicted as follows;

2H₂+O₂→2H₂O

2CO+O₂→2 CO₂

The oxidation catalyst is preferably a supported precious metal catalyst. For example, the catalyst may comprise one or more of Pt, Pd, Rh, Ir or Ru, desirably on an oxidic support such as alumina, titania, zirconia or silica. The amount of precious metal may be in the range at 0.1 to 5% by weight. The oxidation catalyst may be in the form of pellets or extrudates, a foam, monolith or coating on an inert support. Precious metal oxidation catalysts suitable for CO-oxidation preferably consist of alumina-supported platinum promoted with an oxide of a metal selected from the group consisting of manganese, iron, cobalt, copper, nickel and mixtures thereof. Particularly suitable catalysts are alumina-supported platinum catalysts promoted with iron oxide and/or copper oxide. The loading of platinum on a particulate support material should be in the range of from about 1 to 5 weight percent, preferably about 1 to 3 weight percent. The copper loading, if present, should be from about 2-12 weight percent, and preferably 4-8 weight percent. The iron loading, if present, is desirably from about 0.1-2 weight percent, and preferably from about 0.2-1 weight percent. Such catalysts are described in U.S. Pat. No. 20,062,76332 A1, U.S. Pat. Nos. 6,559,094 and 3,088,919. Alternatively, the oxidation catalyst may consist of a supported copper oxide. For example, CN102407123A discloses CuO supported on ceria as a preferential CO-oxidation catalyst. The selectivity of the oxidation catalyst to CO oxidation is preferably at least 50%.

The oxidation reaction is exothermic, and the reaction may be performed adiabatically in a fixed bed oxidation vessel. The flow through the bed may be axial and/or radial flow. The inlet temperature in such an arrangement may be in the range of 20 to 200° C., and the exotherm in the bed is desirably kept below 75 degrees Celsius. Lower temperatures in the catalyst bed generally favour greater selectivity to CO-oxidation and are preferred. Therefore, it is preferable to locate an adiabatic oxidation vessel downstream of one or more stages of cooling and condensate recovery. In this way a higher selectivity can be achieved, which limits the temperature rise across the adiabatic catalyst bed and affords a longer catalyst lifetime.

In some embodiments, it is preferred to operate the oxidation unit with staged oxygen addition. In such embodiments, the oxidation unit may comprise two or more adiabatic oxidation reactors in series. A first oxygen-containing gas stream may be fed to the first oxidation reactor to carry out a first stage of selective CO oxidation. The effluent from the first oxidation reactor may be cooled in indirect heat exchange, for example with cooling water or with a process stream, to form a first cooled effluent stream. A second oxygen-containing gas stream may be added to the first cooled effluent stream and the resulting mixture fed to a second oxidation reactor to carry out a second stage of selective CO oxidation. The sequence may be repeated with additional reaction, cooling and oxygen addition stages.

The oxidation step may alternatively be operated with cooling of the catalyst bed by passing a gaseous or liquid coolant, such as a suitable process stream, preferably steam or a boiling water-steam mixture, through one or more tubes disposed within the catalyst bed. Alternatively, the catalyst can be in tubes surrounded by boiling water. Where a cooled oxidation reactor is used, it is possible to locate the oxidation unit directly downstream of the water-gas shift unit, especially where the water gas shift unit comprises an isothermal shift vessel, with no cooling stage in between. In this arrangement, the gas mixture fed to the oxidation unit is the hydrogen-enriched reformed gas containing steam and the inlet temperature for the oxidation unit will be close to the exit temperature from the water-gas shift unit and may be in the range 200 to 320° C. Where the coolant is water under pressure such that partial, or complete, boiling takes place, the water pressure is preferably the same as in the isothermal shift converter, so that a single steam drum can be shared by the isothermal water-gas shift and oxidation units. Alternatively, the water pressure in the cooled oxidation unit may be different from the water pressure in the isothermal water-gas shift unit, preferably lower.

A cooled oxidation unit may also be used in embodiments where an isothermal water-gas shift converter is not used. In such embodiments, the water gas shift unit may comprise one or more adiabatic reactors. The water pressure in the cooled oxidation unit may range from atmospheric to 50 bar.

Additionally, to limit the peak temperature in a cooled oxidation unit, the oxidation unit may comprise two or more cooled catalyst beds in series, and part of the oxygen-rich gas may be added in stages between successive catalyst beds. The two or more cooled catalyst beds may be contained within the same pressure vessel or within different pressure vessels.

In the present invention the oxidation unit is fed with an oxygen-rich gas, preferably a portion of the same oxygen-rich gas fed to the autothermal reformer. Thus, the oxygen-rich gas fed to the oxidation unit preferably comprises at least 90% vol O₂, more preferably at least 95% vol O₂, most preferably at least 98% vol O₂, or at least 99% vol O₂, e.g. a pure oxygen gas stream. In some arrangements the oxygen may be provided by electrolysis, using renewable sources of electricity, or electricity produced by a turbine powered from the process, e.g., from combustion of a portion of the hydrogen product or steam provided by combustion of a portion of the hydrogen product. In order to ensure high conversion of the residual carbon monoxide, the oxygen may be added in stoichiometric excess, but too high an excess may cause unwanted side reactions. Consequently, the oxygen in the gas mixture is preferably less than 100% in excess of the stoichiometric amount.

The oxidation unit produces a carbon dioxide-enriched gas mixture. Following the oxidation step, the carbon dioxide-enriched gas mixture is cooled to below the dew point to cause condensation of steam present in the gas mixture.

The cooling may be performed in heat exchange in one or more stages using water, air, or a combination of these. In a preferred embodiment, cooling may also be performed in heat exchange with one or more liquids in the CO₂ separation unit to improve process efficiency.

The cooled gas mixture may then be fed to a first gas-liquid separator, to separate the gas mixture from the condensate and form a de-watered carbon dioxide-enriched gas stream. If desired, the separated gas may be further cooled with water and/or air and fed to a second separator, before optional further cooling with water and/or air and feeding to a third separator. Some or all of the condensate may be used to generate steam for the steam reforming and/or water-gas shift stages.

Carbon dioxide is separated from the resulting de-watered carbon dioxide-enriched gas stream to produce a hydrogen product stream.

The carbon dioxide separation stage may be performed using a physical wash system or a reactive wash system, preferably a reactive wash system, especially an amine wash system. The carbon dioxide may be separated by an acid gas recovery (AGR) process. In the AGR process the carbon dioxide-enriched gas stream is contacted with a stream of a suitable absorbent liquid, such as an amine, particularly methyl diethanolamine (MDEA) solution so that the carbon dioxide is absorbed by the liquid to give a laden absorbent liquid and a gas stream having a decreased content of carbon dioxide. The laden absorbent liquid is then regenerated by heating and/or reducing the pressure, to desorb the carbon dioxide and to give a regenerated absorbent liquid, which is then recycled to the carbon dioxide absorption stage. Alternatively, methanol or a glycol may be used to capture the carbon dioxide in a similar manner as the amine. In one arrangement, at least part of this heating is in heat exchange with the hydrogen-enriched reformed gas stream recovered from the water-gas shift unit. In another arrangement, at least part of this heating is in heat exchange with the carbon dioxide-enriched gas mixture recovered from the oxidation unit. If the carbon dioxide separation step is operated as a single pressure process, i.e. essentially the same pressure is employed in the absorption and regeneration steps, only a little recompression of the recycled carbon dioxide will be required.

The recovered carbon dioxide, e.g. from the AGR, may be compressed and used for the manufacture of chemicals such as methanol, or sent to storage or sequestration or used in enhanced oil recovery (EOR) processes. Compression may be accomplished using an electrically driven compressor powered by renewable electricity. In cases where the CO₂ is to be compressed for storage, transportation, use in EOR processes or conversion to other chemical products, the CO₂ may be dried to prevent liquid water present in trace amounts, from condensing. For example, the CO₂ may be dried to a dew point≤−10° C. by passing it through a bed of a suitable desiccant, such as a zeolite, or contacting it with a glycol in a glycol drying unit.

Upon the separation of the carbon dioxide, the process provides a crude hydrogen product gas stream. The crude hydrogen stream may comprise 95-99% vol hydrogen with the balance comprising methane, carbon monoxide, carbon dioxide and inert gases. The methane content may be in the range 0.25-1.5% vol, preferably 0.25-0.5% vol. The carbon monoxide content may be less than 100 ppmv or 50 ppmv, preferably less than 20 ppmv, more preferably less than 10 ppmv. The carbon dioxide content may be in the range 0.01-0.5% vol, preferably 0.01-0.1% vol. The balance may be made up of nitrogen and residual water vapour.

Where, for example, the hydrogen product is to be conveyed by pipeline, it is desirably pre-dried. The drying step may be performed using conventional glycol driers or molecular sieves in a similar manner to the drying of the CO₂.

Whereas the hydrogen gas stream is pure enough for many duties, if desired, the hydrogen product gas stream may be passed to a purification unit to provide a purified hydrogen gas and a fuel gas. If used, at least a portion of the fuel gas may be used in the process as an alternative to external fuel sources in order to minimise the CO₂ emissions from the process. The purification unit may suitably comprise a membrane system, a temperature swing adsorption system, or a pressure swing adsorption (PSA) system. Such systems are commercially available. The purification unit can produce a pure hydrogen stream preferably with a purity greater than 99.5% vol, more preferably greater than 99.9% vol.

However, unlike prior art processes requiring high purity hydrogen, a purification unit such as a PSA unit, is not required in the present invention. Accordingly, the process may be operated without a purification unit, such as a pressure-swing absorption unit.

The hydrogen product gas, with or without purification in a purification unit, may be compressed and used in downstream power or heating process, for example, by using it as fuel in a gas turbine (GT) or by injection into a domestic or industrial networked gas piping system. The hydrogen product, optionally after further purification, may also be used in a downstream chemical synthesis process. Thus, the hydrogen product may be purified and used to produce ammonia by reaction with nitrogen in an ammonia synthesis unit. Alternatively, the hydrogen product may optionally be purified and used with a carbon dioxide-containing gas to manufacture methanol in a methanol production unit. Alternatively, the hydrogen product may be purified and used with a carbon-monoxide containing gas to synthesise hydrocarbons in a Fischer-Tropsch production unit. Any known ammonia, methanol or Fischer-Tropsch production technology may be used. Alternatively, the hydrogen may be used to upgrade hydrocarbons, e.g. by hydro-treating or hydro-cracking hydrocarbons in a hydrocarbon refinery, or in any other process where pure hydrogen may be used. Compression may again be accomplished using an electrically driven compressor powered by renewable electricity.

A portion of the hydrogen product, with or without purification, may be compressed if necessary and recycled to the hydrocarbon feed if desired for desulphurisation and to reduce the potential for carbon formation in the pre-reformer or gas-heated reformer.

In some arrangements, the hydrogen may be combusted directly, without the need for recompression, in a gas turbine. The turbine exhaust gas may be used to raise process steam and cater for the heating needs of the process.

If an application for the hydrogen is for producing electricity, the majority of the product hydrogen can be sent to the gas turbine, and the excess heat used to produce further electricity by raising high-pressure steam and expanding it through a steam turbine, for example as practiced in conventional combined cycle power plants. Medium-pressure steam can be extracted from the appropriate stages of the steam turbine and sent to the process, thus enhancing the heat integration in the hydrogen plant and the power plant for better energy utilization. The heat recovery exercise can be also completed at low temperature from both the hydrogen and the power plants by district heating.

In this way a superior use of the energy of the process may be realised compared to the prior art processes. Simply adding the oxidation unit offers up to a 60% reduction in CO₂ emissions. For a 100,000 Nm³/h hydrogen plant, this corresponds to about 30 tonnes of CO₂ per day, or 10,000 tonnes per year. Omitting a PSA unit would lead to lower capital expenditure plus higher operational flexibility. Using a hydrogen-fired gas turbine in the process provides higher exergy efficiency, lower electricity import (or net electricity export). Providing heat integration between the hydrogen plant a power plant also gives a higher exergy efficiency than if the plants were operating separately, because the medium-pressure steam extracted from the steam turbine to the hydrogen plant has done some work in the high-pressure stages of the turbine, producing electricity. Furthermore, if low-temperature heat recovery from the hydrogen and or the power plant to a heat network is also included, the energy efficiency of the whole system would be yet further increased.

The invention is illustrated by reference to the accompanying drawing in which:

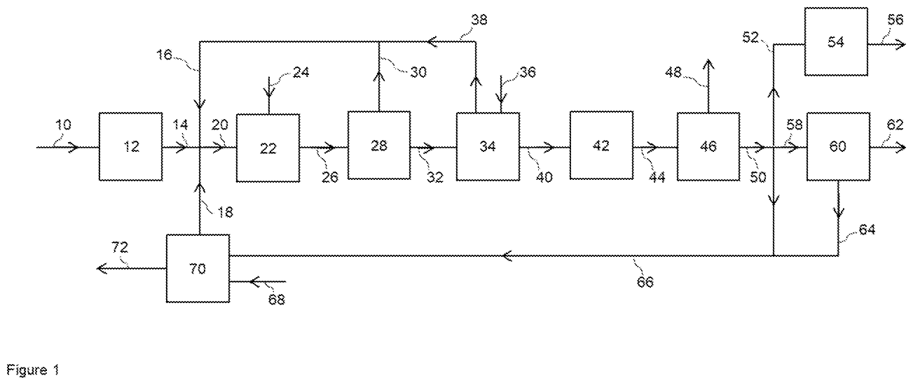

FIG. 1 depicts a flowsheet of one embodiment of the invention,

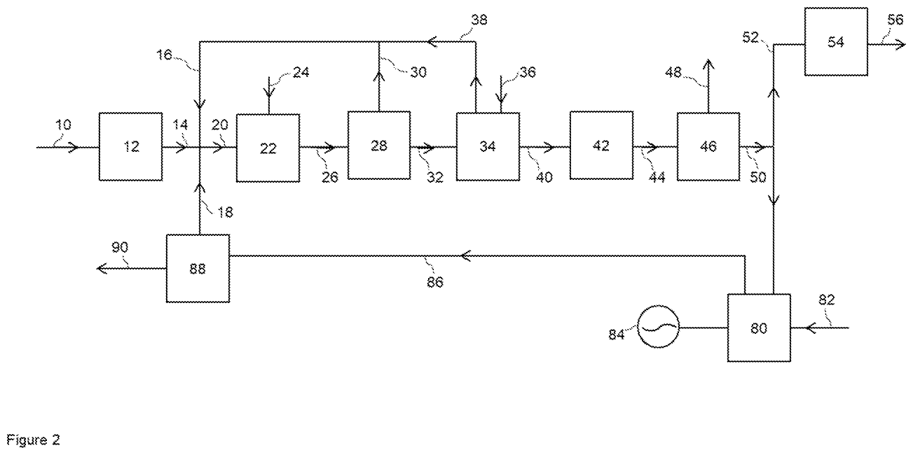

FIG. 2 depicts a flowsheet of another embodiment of the invention,

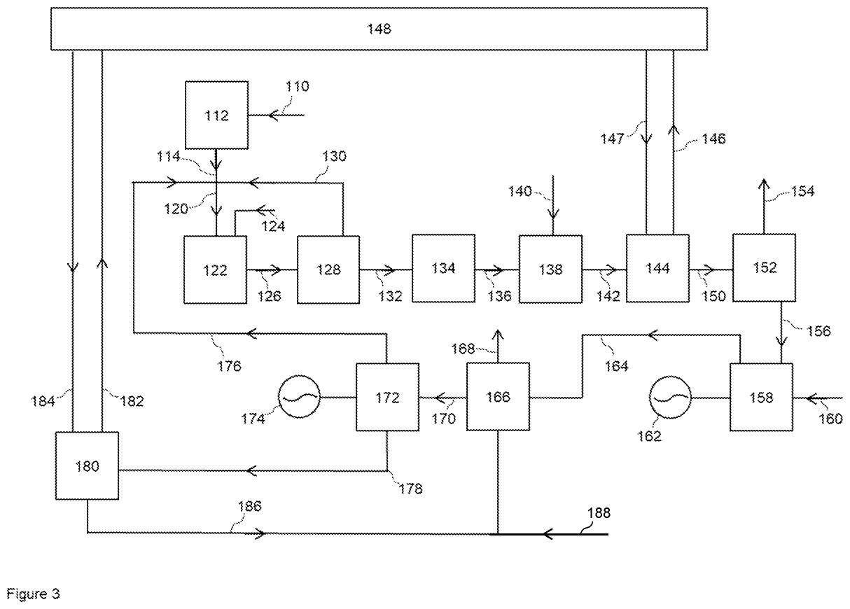

FIG. 3 depicts a flowsheet of yet another embodiment of the invention, and

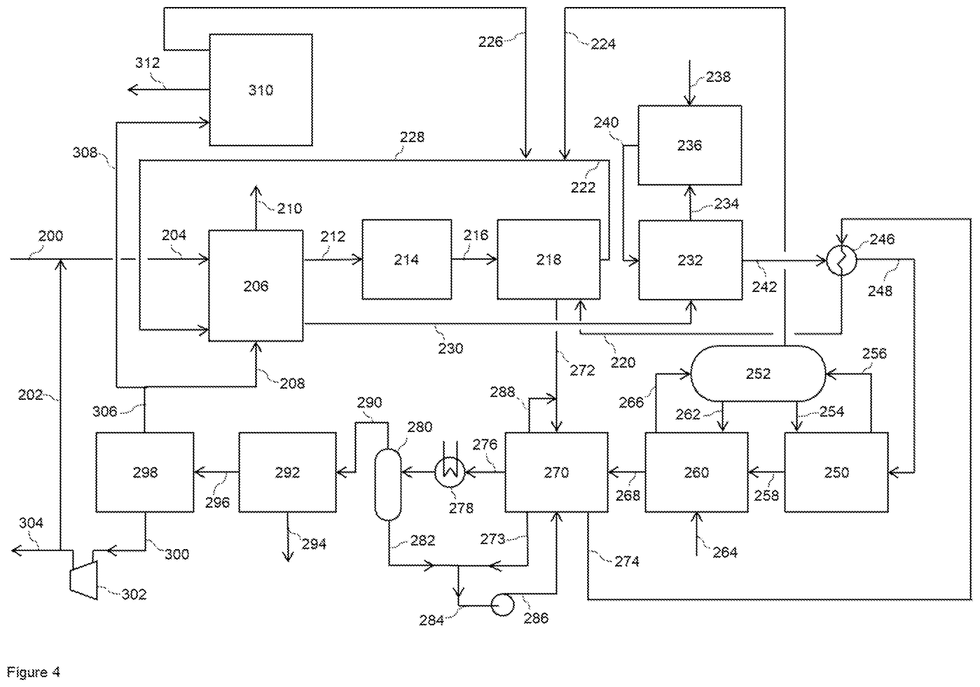

FIG. 4 depicts a flowsheet of yet another embodiment of the invention.

It will be understood by those skilled in the art that the drawings are diagrammatic and that further items of equipment such as reflux drums, pumps, vacuum pumps, temperature sensors, pressure sensors, pressure relief valves, control valves, flow controllers, level controllers, holding tanks, storage tanks, and the like may be required in a commercial plant. The provision of such ancillary items of equipment forms no part of the present invention and is in accordance with conventional chemical engineering practice.

In FIG. 1, a natural gas stream 10 is treated in a purification and saturation unit 12 to desulphurisation comprising hydrodesulphurisation over a hydrodesulphurisation catalyst and adsorption of hydrogen sulphide on a hydrogen sulphide adsorbent, followed by saturation with steam using a saturator to form a saturated natural gas mixture 14. The steam ratio of the saturated natural gas mixture 14 is increased by addition of saturated medium pressure steam via line 16 and superheated medium pressure steam via line 18. The resulting gaseous mixture 20 of steam and natural gas is passed to a synthesis gas generation unit 22 comprising a gas-heated reformer (GHR) and autothermal reformer (ATR) in series. The gaseous mixture 20 is subjected to a first step of steam reforming in the gas-heated reformer over a particulate nickel steam reforming catalyst disposed in a plurality of externally heated tubes followed by autothermal reforming with an oxygen gas stream 24 in an autothermal reformer containing a bed of nickel steam reforming catalyst. A reformed gas recovered from the autothermal reformer is used to heat the tubes of the gas-heated reformer thereby producing a partially cooled reformed gas 26, which is fed to a water-gas shift unit 28 comprising an isothermal water-gas shift vessel containing a bed of water-gas shift catalyst cooled by boiling water under pressure. The exothermic water-gas shift reaction generates steam, which is recovered from the water-gas shift unit 28 via line 30. A hydrogen-enriched gas mixture is recovered from the water-gas shift unit 28 and fed via line 32 to an oxidation unit 34 comprising an oxidation vessel containing a fixed bed of a precious metal CO-oxidation catalyst. A further oxygen-rich gas stream is added via line 36 to the oxidation vessel. Carbon monoxide is oxidised to form a carbon dioxide-enriched gas mixture. In this embodiment, the CO-oxidation catalyst in the oxidation vessel is cooled by boiling water under pressure that is converted to steam by the exothermic oxidation reactions. Steam is recovered from the oxidation unit 34 via line 38. In this embodiment, the pressure of the steam 38 is the same as the steam recovered via line 30, such that the streams 38 and 30 are combined to form the supplemental steam added to the saturated natural gas 14 via line 16. Carbon dioxide-enriched gas recovered from the oxidation unit 34 via line 40 is subjected to heat recovery in a heat recovery unit 42 that cools the carbon dioxide-enriched gas 40 in a final step to below the dew point in heat exchange with cold water to condense steam. Liquid condensate is separated from the gas in one or more gas-liquid separators (not shown) and fed to the saturator in unit 12. A de-watered carbon-dioxide enriched gas recovered from the one or more gas-liquid separator is fed via line 44 to a carbon dioxide removal unit 46 operating by means of reactive absorption, which removes carbon dioxide from the gas mixture, thereby producing a carbon dioxide stream 48 which is compressed and sent for storage or conversion into chemicals. By removing carbon dioxide from the feed gas 44, the carbon dioxide removal unit produces a hydrogen product gas stream which is recovered from the carbon dioxide removal unit via line 50. In this embodiment, the hydrogen product stream 50 is divided into three portions. A first portion of the hydrogen product stream is passed via line 52 to a dehydration unit 54 operating by means of glycol dehydration that dries the product hydrogen stream, thereby producing a fuel-grade product hydrogen stream 56. A second portion of the hydrogen product stream is passed via line 58 to a pressure-swing absorption unit 60 that purifies the hydrogen product by removing trace amounts of methane and carbon oxides to provide a high-purity hydrogen product stream 62. The pressure swing absorption unit 60 produces a tail gas stream 64 containing methane and carbon oxides as well as some hydrogen. The remaining third portion of the hydrogen product stream 50 is combined with the tail gas stream 64 to form a fuel gas stream 66 that is combusted with combustion air stream 68 in a feed preheater and steam boiler unit 70 that is used to preheat the natural gas stream 10 and the natural gas and steam mixture 20 upstream of the synthesis gas generation unit 22. The unit 70 further provides the superheated medium pressure steam via line 18 and generates a flue gas stream 72.

In FIG. 2, a hydrogen product gas stream 50 is produced in the same manner as described in FIG. 1. In this embodiment, the hydrogen product stream 50 is divided into two portions. A first portion of the hydrogen product stream is passed via line 52 to a dehydration unit 54 operating by means of glycol dehydration that dries the product hydrogen stream, thereby producing a fuel-grade product hydrogen stream 56. The remaining portion of the hydrogen product stream 50 is fed to a gas turbine unit 80 where it is combusted with air fed via line 82 to generate electricity 84, which is used in the process, e.g. to drive an air separation unit to provide the oxygen gas streams used in the autothermal reforming and oxidation vessel. Electricity may also be exported. Exhaust gas recovered from the gas turbine via line 86 is used to generate superheated medium pressure steam 18 in a heat recovery steam generator unit 88. The spent exhaust gas is recovered from the heat recovery unit 88 via line 90. In this embodiment, heating of the natural gas stream 10 before desulphurisation is provided by heat exchange with medium pressure steam generated in the unit 88. Medium pressure steam 18 for the steam reforming is provided by the same unit 88. However, heating of the natural gas and steam mixture 20 is provided by means of heat exchange in a feed-effluent heat exchanger (not shown) between the tube-side feed and the shell-side effluent of the gas-heated reformer.

In FIG. 3, a natural gas stream 110 is treated in a purification and saturation unit 112 to desulphurisation comprising hydrodesulphurisation over a hydrodesulphurisation catalyst and adsorption of hydrogen sulphide on a hydrogen sulphide adsorbent, followed by saturation with steam using a saturator to form a saturated natural gas mixture 114. The steam ratio of the saturated natural gas mixture 114 may be increased by addition of saturated medium pressure steam via line 130 and superheated medium pressure steam via line 176. The resulting gaseous mixture 120 of steam and natural gas is passed to a synthesis gas generation unit 122 comprising a gas-heated reformer (GHR) and autothermal reformer (ATR) in series. The gaseous mixture 120 is subjected to a first step of steam reforming in the gas-heated reformer over a particulate nickel steam reforming catalyst disposed in a plurality of externally heated tubes followed by autothermal reforming with an oxygen gas stream 124 in an autothermal reformer containing a bed of nickel steam reforming catalyst. A reformed gas recovered from the autothermal reformer is used to heat the tubes of the gas-heated reformer thereby producing a partially cooled reformed gas 126, which is fed to a water-gas shift unit 128 comprising an isothermal water-gas shift vessel containing a bed of water-gas shift catalyst cooled by boiling water under pressure. The exothermic water-gas shift reaction generates steam, which is recovered from the water-gas shift unit 128 via line 130 and fed to the saturated natural gas stream 114. A hydrogen-enriched gas mixture is recovered from the water-gas shift unit 128 via line 132 and fed to a heat recovery unit 134, where it is cooled to below the dew point in heat exchange with cold water to condense water therefrom. Condensate is recovered from the cooled mixture using one or more gas-liquid separators (not shown) and fed to the saturator in unit 112. A de-watered hydrogen-enriched gas recovered from heat recovery unit 134 is heated and fed via line 136 to an oxidation unit 138 comprising an oxidation vessel containing a fixed bed of a promoted platinum CO-oxidation catalyst. A further oxygen-rich gas stream is added via line 140 to the oxidation vessel. Carbon monoxide is oxidised to form a carbon dioxide-enriched gas mixture. In this embodiment, the CO-oxidation catalyst is operated adiabatically. Carbon dioxide-enriched gas recovered from the oxidation unit 138 via line 142 is subjected to heat recovery in a low temperature heat recovery unit 144 that cools the carbon dioxide-enriched gas 142 to below the dew point in heat exchange with cold water to condense steam. Heated water recovered from unit 144 may be sent via line 146 to a district heating facility 148 and cooled water returned to the heat recovery unit 144 via line 147. Liquid condensate is separated from the carbon dioxide-enriched gas in one or more gas-liquid separators (not shown) and may be fed to the saturator in unit 112. A de-watered carbon-dioxide enriched gas recovered from the one or more gas-liquid separator is fed via line 150 to a carbon dioxide removal unit 152 operating by means of reactive absorption, which removes carbon dioxide from the gas mixture, thereby producing a carbon dioxide stream 154 which is compressed and sent for storage or conversion into chemicals. By removing carbon dioxide from the feed gas 150, the carbon dioxide removal unit produces a hydrogen product gas stream which is recovered from the carbon dioxide removal unit via line 156. In this embodiment, all of the hydrogen product stream 156 is fed to a gas turbine unit 158 where it is combusted with air fed via line 160 to generate electricity 162, which is used in the process, e.g. to drive an air separation unit to provide the oxygen gas streams used in the autothermal reforming and oxidation vessel. Electricity may also be exported. Exhaust gas recovered from the gas turbine via line 164 is used to generate and superheat steam in a heat recovery steam generator unit 166. Spent exhaust gas is recovered from the unit 166 via line 168. In this embodiment, superheated high pressure steam generated by the heat recovery steam generator in unit 166 is fed via line 170 to a steam turbine 172. The steam turbine 172 is used to generate additional electricity 174 and may provide superheated medium pressure steam via line 176 to be added to the saturated natural gas stream 114. A steam turbine exhaust stream 178 is subjected to separate low-temperature heat recovery in heat recovery unit 180, with heated water fed from unit 180 via line 182 to district heating facility 148. The district heating facility returns cooled water to the low temperature heat recovery unit 180 via line 184. Boiler feed water recovered from the low temperature heat recovery unit 180 is fed via line 186 to feed the heat recovery steam generator unit 166. Optionally, make-up boiler feed water may be provided via line 188 to balance the steam extracted through line 176 from steam turbine 172. In this embodiment, heating of the natural gas and steam mixture 120 is provided by means of heat exchange in a feed-effluent heat exchanger (not shown) between the tube-side feed and the shell-side effluent of the gas-heated reformer.

The embodiment of FIG. 1 may be employed when at least part of the product hydrogen needs to meet high purity specifications, for example to be used in downstream synthesis processes. In this case, the main benefit of the CO oxidation unit is to decrease onsite carbon emissions by decreasing the amount of CO present in the fuel gas. The heat produced by the CO oxidation reaction is used to raise part of the process steam.

The embodiment of FIG. 2 may be employed when all the product hydrogen is to be exported as fuel and no high purity hydrogen is needed. In this case, one further advantage of the CO oxidation unit is that it eliminates the need for a PSA purification step. A further advantage of this, is that the low-pressure PSA tail gas is also eliminated, so that all the product hydrogen is available at pressure. Part of the product hydrogen can therefore be combusted in a gas turbine without the need to recompress it. Because the gas turbine produces mechanical work or electricity, this is embodiment provides a more exergy-efficient way to utilize the high-temperature heat produced by fuel combustion. Moreover, decarbonized electricity is a welcome by-product, which can contribute towards meeting the power demand generated by an ever-increasing number of electric vehicles.

The embodiment of FIG. 3 may be employed when it is desired to decarbonize a process for the combined generation of heat and power (CHP). In this case, a combined cycle power plant can be heat integrated with the low-carbon hydrogen plant, and low-temperature waste heat from both plants can be exported to a heat network (district heating). In this embodiment, the CO oxidation unit is not operated isothermally to raise medium temperature steam. It is operated adiabatically, at a lower temperature, to increase the amount of low-temperature heat that can be exported to the heat network.

FIG. 4 is an adaptation of the embodiment of FIG. 1, where 100% of the hydrogen product gas stream is purified in a PSA unit.

In FIG. 4, a natural gas stream 200 is combined with a small stream of hydrogen provided via line 202 and fed via line 204 to coils in a fired heater 206 where it is heated by combusting a portion of a PSA off gas to generate a flue gas 210. The heated natural gas is fed from heater 206 via line 212 to a purification unit 214 in which it is subjected to desulphurisation by hydrodesulphurisation over a hydrodesulphurisation catalyst followed by adsorption of hydrogen sulphide on a hydrogen sulphide adsorbent. The desulphurised natural gas is fed via line 216 to a saturator 218 in which it is saturated with steam by contacting with hot water fed to the saturator via line 220. A saturated natural gas stream is recovered from the saturator 218 via line 222. Medium pressure steam is added to the saturated natural gas via line 224 and superheated steam is added to the saturated natural gas via line 226. The resulting mixture of natural gas and steam is fed via line 228 to coils in the fired heater 206, where it is heated before passing it via line 230 to externally heated, catalyst-containing tubes of a gas-heated reformer 232. The gaseous mixture 230 is subjected to a first step of steam reforming in the gas-heated reformer 232. A partially reformed gas is recovered from the gas-heated reformer 232 and fed via line 234 to a burner in an autothermal reformer 236 where it is subjected to partial combustion with an oxygen-containing gas fed via line 238 and passed through a fixed bed of steam reforming catalyst disposed downstream of the burner to further reform the gas mixture. An autothermally-reformed gas mixture is recovered from the autothermal reformer 236 and passed via line 240 to a shell side of the gas-heated reformer 232, where is passes around the catalyst-containing tubes, thereby providing the heat for the first reforming step. A partially cooled reformed gas is recovered from the shell side of the gas-heated reformer via line 242, cooled in heat exchanger 246, and fed via line 248 to an isothermal water-gas shift vessel 250 containing a bed of copper-based water gas shift catalyst that is cooled in heat exchange with boiling water under pressure provided to the vessel 250 from a steam drum 252 via line 254. The exothermic water-gas shift reaction occurs in the vessel 250 generating steam that is returned to the steam drum 252 via line 256. A hydrogen-enriched gas mixture is recovered from the isothermal water-gas shift vessel 250 and fed, without cooling, via line 258 to the inlet of an oxidation vessel 260 containing a fixed bed of a precious metal oxidation catalyst that is cooled in heat exchange with boiling water under pressure provided to the oxidation vessel 260 from the steam drum 252 via line 262. The oxidation vessel 260 is fed with an oxygen containing gas via line 264. Exothermic oxidation reactions occur generating steam that is returned to the steam drum 252 via line 266. The pressure of the coolant for both vessels 250 and 260 is the same, which permits the use of the common steam drum 252. Medium pressure steam recovered from the steam drum 252 is fed via line 224 to the saturated natural gas 222. Carbon monoxide in the hydrogen-enriched gas is oxidised in the oxidation vessel 260 to from carbon dioxide and a carbon dioxide-enriched gas is passed from the unit 260 via line 268 to a heat recovery unit 270. The carbon dioxide-enriched gas is cooled in the heat recovery unit 270 in heat exchange with water fed via line 272 from the saturator 218. The heat recovery unit 270 produces a condensate stream that is recovered from the heat recovery unit 270 via line 273. The cooled carbon dioxide-enriched gas 276 from heat recovery unit 270 is further cooled to below the dew point using cold water in heat exchanger 278 and the resulting mixture fed to a gas-liquid separator 280, where further liquid condensate is separated to form a de-watered carbon dioxide-enriched gas. Condensate recovered from the gas liquid separator 280 via line 282, is combined with condensate stream 273 from the heat recovery unit 270, and the combined stream circulated via pump 284 to the heat recovery unit 270, where it is heated in exchange with the carbon dioxide-enriched gas. The resulting heated condensate is then combined via line 288 with the saturator water in line 272 fed to the heat recovery unit 270 to be further heated, before being fed via line 274, heat exchanger 246 and line 220 to the saturator 218. The de-watered carbon dioxide-enriched gas recovered from the gas-liquid separator 280 is fed via line 290 to a carbon dioxide removal unit 292 operating by means of reactive absorption, which removes carbon dioxide from the gas mixture, thereby producing a carbon dioxide stream 294, which is compressed and sent for storage or conversion into chemicals. By removing carbon dioxide from the feed gas 290, the carbon dioxide removal unit 292 produces a hydrogen product gas stream which is recovered via line 296. In this embodiment, all of the hydrogen product stream 296 is fed to a pressure swing absorption unit 298. The pressure swing absorption unit separates trace amounts of methane, carbon dioxide and nitrogen from the hydrogen product, thereby producing a purified hydrogen product stream, which is recovered from the pressure swing absorption unit 298 via line 300. The purified hydrogen product is then compressed in compressor 302 to provide a compressed purified hydrogen stream 304 for export. A small portion of the compressed purified hydrogen is fed from line 304 via line 202 to the natural gas steam 200 to provide hydrogen for the hydrodesulphurisation in purification unit 214. The pressure swing absorption unit produces a tail gas stream 306 containing hydrogen and small amounts of methane and nitrogen, which is recovered via line 306 for use in heating feeds and generating steam for the process. A portion of the tail gas stream 306 is fed via line 208 to the feed fired heater 206, where it is combusted to generate heat. The remaining portion of the tail gas stream 306 is fed via line 308 to fire a steam boiler and superheater 310, which generates superheated steam that is fed from the boiler and superheater 310 via line 226 to the saturated natural gas stream 222. The boiler and superheater 310 generate a flue gas 312.

The invention is further illustrated by reference to the following calculated example of a process in accordance with the flowsheet depicted in FIG. 4.

| | | Stream Number | | | | | | | | |
|---|---|---|---|---|---|---|---|---|---|---|
| | | 200 | 202 | 204 | 208 | 210 | 212 | 216 | 220 | 222 |
| Molar Flow | kNm³/h | 36.1 | 0.8 | 36.9 | 7.4 | 24.0 | 36.9 | 36.9 | 489.4 | 112.8 |
| Mass Flow | t/h | 29.0 | 0.1 | 29.1 | 1.2 | 27.0 | 29.1 | 29.1 | 393.5 | 90.3 |
| Temperature | ° C. | 40.0 | 123.8 | 40.6 | 45.2 | 140.0 | 230.0 | 225.6 | 245.8 | 229.2 |
| Pressure | bara | 46.2 | 50.5 | 46.0 | 1.4 | 1.0 | 44.4 | 43.3 | 43.0 | 42.7 |
| Molar | Unit | | | | | | | | | |
| Composition | | | | | | | | | | |
| Methane | mol % | 89.00 | 0.00 | 87.07 | 3.23 | 0.00 | 87.07 | 87.07 | 0.24 | 28.46 |
| Ethane | mol % | 7.00 | 0.00 | 6.85 | 0.00 | 0.00 | 6.85 | 6.85 | 0.00 | 2.24 |
| Propane | mol % | 1.00 | 0.00 | 0.98 | 0.00 | 0.00 | 0.98 | 0.98 | 0.00 | 0.32 |
| Butanes | mol % | 0.10 | 0.00 | 0.10 | 0.00 | 0.00 | 0.10 | 0.10 | 0.00 | 0.03 |
| Pentanes | mol % | 0.01 | 0.00 | 0.01 | 0.00 | 0.00 | 0.01 | 0.01 | 0.00 | 0.00 |
| Hydrogen | mol % | 0.00 | 99.90 | 2.17 | 91.51 | 0.00 | 2.17 | 2.00 | 0.00 | 0.66 |
| Carbon Dioxide | mol % | 2.00 | 0.00 | 1.96 | 0.07 | 1.05 | 1.96 | 1.79 | 0.04 | 0.70 |
| Carbon Monoxide | mol % | 0.00 | 0.00 | 0.00 | 0.01 | 0.00 | 0.00 | 0.17 | 0.00 | 0.06 |
| Oxygen | mol % | 0.00 | 0.00 | 0.00 | 0.00 | 1.37 | 0.00 | 0.00 | 0.00 | 0.00 |
| Nitrogen | mol % | 0.89 | 0.10 | 0.87 | 2.26 | 65.08 | 0.87 | 0.87 | 0.00 | 0.29 |
| Argon | mol % | 0.00 | 0.00 | 0.00 | 0.00 | 0.79 | 0.00 | 0.00 | 0.00 | 0.00 |
| Water | mol % | 0.00 | 0.00 | 0.00 | 2.88 | 31.70 | 0.00 | 0.17 | 99.70 | 67.22 |
| Methanol | mol % | 0.00 | 0.00 | 0.00 | 0.01 | 0.00 | 0.00 | 0.00 | 0.01 | 0.03 |
| Ammonia | mol % | 0.00 | 0.00 | 0.00 | 0.04 | 0.01 | 0.00 | 0.00 | 0.00 | 0.00 |

| | | Stream Number | | | | | | | |
|---|---|---|---|---|---|---|---|---|---|
| | | 224 | 226 | 228 | 230 | 234 | 238 | 240 | 242 |
| Molar Flow | kNm³/h | 32.8 | 18.4 | 164.0 | 164.0 | 190.6 | 17.6 | 240.7 | 240.3 |
| Mass Flow | t/h | 26.3 | 14.8 | 131.4 | 131.4 | 131.4 | 24.9 | 156.4 | 156.3 |
| Temperature | ° C. | 256.9 | 449.6 | 251.7 | 440.0 | 711.8 | 209.3 | 1020.0 | 521.5 |
| Pressure | bara | 43.0 | 42.9 | 42.5 | 41.0 | 35.5 | 38.0 | 34.0 | 33.4 |
| Molar Composition | Unit | | | | | | | | |
| Methane | mol % | 0.00 | 0.00 | 19.57 | 19.57 | 12.19 | 0.00 | 0.13 | 0.18 |
| Ethane | mol % | 0.00 | 0.00 | 1.54 | 1.54 | 0.41 | 0.00 | 0.00 | 0.00 |
| Propane | mol % | 0.00 | 0.00 | 0.22 | 0.22 | 0.06 | 0.00 | 0.00 | 0.00 |
| Butanes | mol % | 0.00 | 0.00 | 0.02 | 0.02 | 0.00 | 0.00 | 0.00 | 0.00 |
| Pentanes | mol % | 0.00 | 0.00 | 0.00 | 0.00 | 0.00 | 0.00 | 0.00 | 0.00 |
| Hydrogen | mol % | 0.00 | 0.00 | 0.45 | 0.45 | 25.25 | 0.00 | 38.19 | 38.73 |
| Carbon Dioxide | mol % | 0.00 | 0.00 | 0.48 | 0.48 | 5.63 | 0.00 | 6.41 | 7.07 |
| Carbon Monoxide | mol % | 0.00 | 0.00 | 0.04 | 0.04 | 1.78 | 0.00 | 9.79 | 9.09 |
| Oxygen | mol % | 0.00 | 0.00 | 0.00 | 0.00 | 0.00 | 97.74 | 0.00 | 0.00 |
| Nitrogen | mol % | 0.00 | 0.00 | 0.20 | 0.20 | 0.17 | 0.49 | 0.17 | 0.17 |
| Argon | mol % | 0.00 | 0.00 | 0.00 | 0.00 | 0.00 | 0.00 | 0.00 | 0.00 |
| Water | mol % | 100.00 | 100.00 | 77.46 | 77.46 | 54.50 | 1.77 | 45.32 | 44.76 |
| Methanol | mol % | 0.00 | 0.00 | 0.02 | 0.02 | 0.01 | 0.00 | 0.00 | 0.00 |
| Ammonia | mol % | 0.00 | 0.00 | 0.00 | 0.00 | 0.00 | 0.00 | 0.00 | 0.00 |

| | | Stream Number | | | | | | | | |
|---|---|---|---|---|---|---|---|---|---|---|
| | | 248 | 258 | 264 | 268 | 272 | 273 | 274 | 276 | 282 |
| Molar Flow | kNm³/h | 240.3 | 240.1 | 0.7 | 240.1 | 411.7 | 75.1 | 489.4 | 165.0 | 10.8 |
| Mass Flow | t/h | 156.3 | 156.3 | 1.0 | 157.3 | 330.8 | 60.5 | 393.5 | 96.7 | 8.7 |
| Temperature | ° C. | 240.0 | 257.3 | 30.0 | 257.0 | 178.6 | 120.6 | 192.2 | 120.6 | 65.0 |
| Pressure | bara | 32.7 | 31.9 | 40.0 | 31.2 | 42.9 | 29.5 | 46.5 | 29.4 | 29.2 |
| Molar Composition | Unit | | | | | | | | | |
| Methane | mol % | 0.18 | 0.18 | 0.00 | 0.18 | 0.29 | 0.00 | 0.24 | 0.27 | 0.00 |
| Ethane | mol % | 0.00 | 0.00 | 0.00 | 0.00 | 0.00 | 0.00 | 0.00 | 0.00 | 0.00 |
| Propane | mol % | 0.00 | 0.00 | 0.00 | 0.00 | 0.00 | 0.00 | 0.00 | 0.00 | 0.00 |
| Butanes | mol % | 0.00 | 0.00 | 0.00 | 0.00 | 0.00 | 0.00 | 0.00 | 0.00 | 0.00 |
| Pentanes | mol % | 0.00 | 0.00 | 0.00 | 0.00 | 0.00 | 0.00 | 0.00 | 0.00 | 0.00 |
| Hydrogen | mol % | 38.73 | 47.46 | 0.00 | 47.17 | 0.00 | 0.00 | 0.00 | 68.64 | 0.00 |
| Carbon Dioxide | mol % | 7.07 | 15.85 | 0.00 | 16.13 | 0.02 | 0.18 | 0.04 | 23.39 | 0.19 |
| Carbon Monoxide | mol % | 9.09 | 0.28 | 0.00 | 0.00 | 0.00 | 0.00 | 0.00 | 0.00 | 0.00 |
| Oxygen | mol % | 0.00 | 0.00 | 99.50 | 0.00 | 0.00 | 0.00 | 0.00 | 0.00 | 0.00 |
| Nitrogen | mol % | 0.17 | 0.17 | 0.50 | 0.17 | 0.00 | 0.00 | 0.00 | 0.25 | 0.00 |
| Argon | mol % | 0.00 | 0.00 | 0.00 | 0.00 | 0.00 | 0.00 | 0.00 | 0.00 | 0.00 |
| Water | mol % | 44.76 | 36.02 | 0.00 | 36.30 | 99.69 | 99.78 | 99.70 | 7.41 | 99.64 |
| Methanol | mol % | 0.00 | 0.04 | 0.00 | 0.04 | 0.00 | 0.04 | 0.01 | 0.04 | 0.15 |
| Ammonia | mol % | 0.00 | 0.00 | 0.00 | 0.00 | 0.00 | 0.01 | 0.00 | 0.00 | 0.02 |

| | | Stream Number | | | | | | | | | |
|---|---|---|---|---|---|---|---|---|---|---|---|
| | | 286 | 288 | 290 | 294 | 296 | 300 | 304 | 306 | 308 | 312 |
| Molar Flow | kNm³/h | 74.5 | 74.5 | 154.2 | 39.9 | 114.5 | 100.8 | 100.0 | 13.7 | 6.3 | 20.7 |
| Mass Flow | t/h | 60.1 | 60.1 | 88.0 | 76.8 | 11.4 | 9.2 | 9.1 | 2.2 | 1.0 | 23.3 |
| Temperature | ° C. | 121.0 | 195.0 | 65.0 | 96.9 | 45.2 | 45.2 | 123.8 | 45.2 | 45.2 | 140.0 |
| Pressure | bara | 48.3 | 47.0 | 29.1 | 1.7 | 28.9 | 28.4 | 50.5 | 1.4 | 1.4 | 1.0 |
| Molar | Unit | | | | | | | | | | |
| Composition | | | | | | | | | | | |
| Methane | mol % | 0.00 | 0.00 | 0.29 | 0.00 | 0.39 | 0.00 | 0.00 | 3.23 | 3.23 | 0.00 |
| Ethane | mol % | 0.00 | 0.00 | 0.00 | 0.00 | 0.00 | 0.00 | 0.00 | 0.00 | 0.00 | 0.00 |
| Propane | mol % | 0.00 | 0.00 | 0.00 | 0.00 | 0.00 | 0.00 | 0.00 | 0.00 | 0.00 | 0.00 |
| Butanes | mol % | 0.00 | 0.00 | 0.00 | 0.00 | 0.00 | 0.00 | 0.00 | 0.00 | 0.00 | 0.00 |
| Pentanes | mol % | 0.00 | 0.00 | 0.00 | 0.00 | 0.00 | 0.00 | 0.00 | 0.00 | 0.00 | 0.00 |
| Hydrogen | mol % | 0.00 | 0.00 | 73.44 | 0.04 | 98.90 | 99.90 | 99.90 | 91.51 | 91.51 | 0.00 |
| Carbon Dioxide | mol % | 0.18 | 0.18 | 25.01 | 96.70 | 0.01 | 0.00 | 0.00 | 0.07 | 0.07 | 1.05 |
| Carbon Monoxide | mol % | 0.00 | 0.00 | 0.00 | 0.00 | 0.00 | 0.00 | 0.00 | 0.01 | 0.01 | 0.00 |
| Oxygen | mol % | 0.00 | 0.00 | 0.00 | 0.00 | 0.00 | 0.00 | 0.00 | 0.00 | 0.00 | 1.37 |
| Nitrogen | mol % | 0.00 | 0.00 | 0.26 | 0.00 | 0.36 | 0.10 | 0.10 | 2.26 | 2.26 | 65.08 |
| Argon | mol % | 0.00 | 0.00 | 0.00 | 0.00 | 0.00 | 0.00 | 0.00 | 0.00 | 0.00 | 0.79 |
| Water | mol % | 99.78 | 99.78 | 0.96 | 3.15 | 0.34 | 0.00 | 0.00 | 2.88 | 2.88 | 31.70 |
| Methanol | mol % | 0.04 | 0.04 | 0.03 | 0.10 | 0.00 | 0.00 | 0.00 | 0.01 | 0.01 | 0.00 |
| Ammonia | mol % | 0.01 | 0.01 | 0.00 | 0.00 | 0.00 | 0.00 | 0.00 | 0.04 | 0.04 | 0.01 |

The Example illustrates the low CO₂ emissions achievable from the process.

1. A process for the production of hydrogen comprising the steps of:
(i) subjecting a gaseous mixture comprising a hydrocarbon and steam to steam reforming in a gas-heated reformer or adiabatic pre-reformer followed by autothermal reforming with an oxygen-rich gas in an autothermal reformer to generate a reformed gas mixture;
(ii) increasing the hydrogen content of the reformed gas mixture by subjecting it to one or more water-gas shift stages in a water-gas shift unit to provide a hydrogen-enriched reformed gas;
(iii) passing the hydrogen-enriched reformed gas and an oxygen-rich gas to an oxidation unit containing an oxidation catalyst that converts carbon monoxide present in the hydrogen-enriched reformed gas to carbon dioxide, to form a carbon-dioxide enriched gas mixture;
(iv) cooling the carbon dioxide-enriched gas mixture and separating condensed water therefrom; and,
(v) passing the carbon dioxide enriched gas mixture to a carbon dioxide separation unit to provide a carbon dioxide gas stream and a hydrogen product gas stream.

2. The process according to claim 1, wherein the hydrocarbon is a methane-containing gas stream containing >50% vol of methane.

3. The process according to claim 1, wherein the hydrocarbon is desulphurised.

4. The process according to claim 1, wherein the steam to carbon ratio in the gaseous mixture is in the range 0.9:1 to 5:1.

5. The process according to claim 1, wherein the gaseous mixture comprising the hydrocarbon and steam is formed by contacting the hydrocarbon with water in a saturator to form a saturated gas mixture, with optional direct addition of steam to the saturated gas mixture.

6. The process according to claim 1, wherein the oxygen-rich gas comprises at least 90% vol O₂.

7. The process according to claim 1, wherein the water-gas shift stage comprises an isothermal shift stage.

8. The process according to claim 1, wherein the oxidation catalyst comprises one or more of Pt, Pd, Rh, Ir or Ru.

9. The process according to claim 1, wherein there are one, two or three stages of cooling and separation of process condensate from the carbon-dioxide enriched gas mixture before the carbon dioxide removal stage.

10. The process according to claim 1, wherein the carbon dioxide removal stage is performed using a physical wash system or a reactive wash system.

11. The process according to claim 1, wherein the carbon dioxide stream is compressed using an electrically-driven compressor and sent for storage or used for the synthesis of chemicals.

12. The process according to claim 1, wherein the hydrogen product is used in a downstream power process, heating process, a downstream chemical synthesis process or used to upgrade hydrocarbons.

13. The process according to claim 12, wherein the hydrogen product is purified in a purification unit to provide a purified hydrogen product and a tail gas.

14. The process according to claim 13, wherein a portion of the tail gas and a portion of the hydrogen product, before or after purification in the purification unit is fed to one or more fired heaters used to heat feed steams or provide steam for the process.

15. The process according to claim 12, wherein at least a portion of the hydrogen product is combusted with air in a gas turbine to generate electricity and form a hot exhaust gas.

16. The process according to claim 15, wherein the hot exhaust gas is used to heat the hydrocarbon feedstock and/or produce steam for the steam reforming step.

17. The process according to claim 15, wherein the hot exhaust gas is used to heat steam which is fed to a steam turbine to generate additional electricity and produce steam for the steam reforming step.

18. The process according to claim 17, wherein one or more of an exhaust stream from the steam turbine, the hydrogen-enriched reformed gas mixture, and the carbon dioxide-enriched gas are used in a low temperature heat recovery process to provide heat for district heating.
